(19) United States
(12) Patent Application Publication
(10) Pub. No.: US 2010/0300111 A1
(43) Pub. Date: Dec. 2, 2010

(54) METHOD FOR THE OPERATION OF A POWER PLANT FEATURING INTEGRATED GASIFICATION, AND POWER PLANT

(76) Inventors: Carsten Graeber, Erlangen (DE); Gerhard Zimmermann, Hochstadt/Aisch (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/675,146

(22) PCT Filed: Aug. 18, 2008
(86) PCT No.: PCT/EP08/60616

§ 371 Date: Feb. 25, 2010

(30) Foreign Application Priority Data
Aug. 27, 2007 (EP) 07016780.4

(51) Int. Cl. F02C 6/18

(52) U.S. Cl. 60/780

(57) ABSTRACT

A method for operating a power plant with in integrated gasification device is provided. A fossil fuel is gasified and is fed as syngas to a burner associated with a gas turbine for combustion purposes. Oxygen is separated from air by a membrane at a process temperature such that oxygen-depleted air is formed. The separated oxygen is fed to the gasification device in order to react with the fossil fuel, and heating energy is fed to the membrane to maintain the required process temperature. The heating energy is recovered in part from the syngas and in part from the oxygen and/or the oxygen-depleted air in heat exchange with the air, and the heated air is fed to the membrane.

### CROSS REFERENCE TO RELATED APPLICATIONS

This application is the US National Stage of International Application No. PCT/EP2009/027230 filed Aug. 13, 2008, and claims the benefit thereof. The International Application claims the benefits of European Patent Application No. 07016780.4 EP filed Aug. 27, 2007. All of the applications are incorporated by reference herein in their entirety.

### FIELD OF INVENTION

The invention relates to a method for operating a power plant comprising integrated gasification and to a power plant.

### BACKGROUND OF INVENTION

An IGCC plant of this kind is known for example from WO 03/008768. This plant comprises a gasification device in which, for example, particulate coal is converted together with oxygen and steam to form a syngas (partial oxidation). Following several processing steps the syngas is fed as a gaseous fuel to a gas turbine combustion chamber. In WO 03/008768 a cryogenic air separation plant (=LZA) is implanted in the IGCC plant for obtaining oxygen. This separates the air in a thermodynamic process into its essential components, nitrogen and oxygen. The oxygen obtained in the LZA is fed to the gasification device.

In the meantime, membrane-based units have been proposed as an alternative to cryogenic air separation plant. The oxygen ion-conveying membranes lead to an at least partial separation of oxygen from the air. Replacing the cryogenic air separation unit with a membrane is regarded as a potential option for increasing efficiency in conventional IGCC power plant. The implementation of a membrane can also be expected to compensate for the loss in efficiency in the case of CO2-free power plant designs.

An example of a membrane-based oxygen separation can be found in U.S. 2004/0011057 A1 which describes an IGCC plant in which oxygen-rich gas is produced via a membrane, oxygen transportation taking place within the membrane by way of diffusion of oxide ions and the membrane being brought and/or held at operating temperature via a heat exchanger by hot waste gases from the turbine.

U.S. Pat. No. 5,562,754 describes a method of oxygen separation in which gas (air) containing oxygen is directly heated by combusting a fuel in the gas flow, whereby a hot combustion product containing oxygen is produced that is fed to a membrane. Alternatively, the gas containing oxygen is heated by indirect heat exchange with a combustion product that is produced by combustion of the oxygen-deficient air, which remains during oxygen separation, with fuel.

### SUMMARY OF INVENTION

However, membrane-based arrangements for oxygen separation have the drawback that the membrane unit has to be kept at a comparatively high operating temperature for it to be able to carry out the function. Heating energy therefore has to be permanently fed to the membrane reactor, so it is at the requisite process temperature for oxygen separation.

An object of the invention is to provide a method and a power plant which overcome the above-mentioned drawbacks in a membrane=based oxygen separation process.

This object is achieved by a method for operating a power plant and a power plant as claimed in the independent claims.

Further advantageous embodiments are cited in the dependent claims.

In the inventive method heating energy is fed to the membrane to maintain the required process temperature, the heating energy being obtained from the syngas and from the hot oxygen or hot oxygen-depleted air in heat exchange with the air, and the heated air is conveyed to the membrane.

The heat exchange process and its advantageous connection to the high temperature level of the syngas (crude gas) obtained in the gasification device, and the flows of oxygen and oxygen-depleted air that are produced during oxygen separation result in a particularly efficient method of heating the air to the required process temperature and then feeding the heated air to the membrane unit such that it is already at the correct temperature.

The membrane can be brought to and held at the operating temperature, typically 700° C. to 1000° C., particularly easily hereby. A portion of the heating energy brought into the air before oxygen separation is released to the following air in an indirect heat exchange following oxygen separation from oxygen and the oxygen-depleted air respectively. The following air is then completely heated to membrane operating temperature via a syngas/air heat exchange.

It is expedient in this connection to arrange the heat exchangers in a suitable manner with respect to each other. As a result of the higher temperature of the syngas, compared with the temperature of the oxygen or the oxygen-depleted air, it is advantageous to connect the oxygen/air heat exchanger or the oxygen-depleted air/air heat exchanger upstream of the syngas/air heat exchanger. In another advantageous arrangement the three heat exchangers are connected in parallel and the air flows, after heating in the heat exchangers, are conveyed together and as a whole air flow to the membrane.

To bring the membrane to operating temperature at the start of the process it is expedient to obtain the heating energy from the waste gas from a separate combustion in heat exchange with the air. The waste gas cooled after heat exchange with the air is advantageously used in a waste heat steam generator in order to generate steam.

It is also advantageous to use the syngas cooled after heat exchange with the air in a waste heat steam generator connected downstream of the syngas/air heat exchanger in order to generate steam.

It is also advantageous to further prepare the syngas after heat exchange with the air, in particular to purify it, before it is subjected to a CO shift reaction. The main components, CO2 and hydrogen, are then the main components, CO2 and hydrogen, are then advantageously separated. The hydrogen is diluted with an inert medium, preferably steam (H₂O), as needed, before it is combusted in a gas turbine.

The compressed air required for oxygen separation is expediently removed as compressor exhaust air from a compressor part associated with a gas turbine, the removal of air advantageously being carried out at the compressor outlet after the end stage or optionally being carried out at a lower compressor air pressure level.

The oxygen-depleted air “remaining” after oxygen separation and cooled in heat exchange with the air coming from the compressor is advantageously fed as combustion air to the burner of the gas turbine, whereby the temperature of combustion is advantageously lowered. Unlike in cryogenically-operating air separation plant, sufficiently pure oxygen is not available as a product following oxygen separation via the membrane, which oxygen could be added to the syngas to improve the combustion characteristics. The addition of air is not an option owing to the oxygen content.

Waste gases from the gas turbine are expediently used in a waste heat steam generator connected downstream of the gas turbine in order to generate steam. The superheated steam can then advantageously be used in a steam turbine, or as a diluting medium for the fuel or to render the fuel inert, and as a carrier gas during conveying to the gasification device. If CO2 is separated from the syngas, however, it is expedient to render the fuel inert with CO2 or to use CO2 as the carrier gas and to advantageously use the generated steam in a steam turbine.

The inventive power plant comprises a gas turbine with which a combustion chamber having at least one burner is associated, a fuel treatment process system connected upstream of the combustion chamber having a gasification device with a fuel feed pipeline for fossil fuel and a gas pipeline that branches from the gasification device and ends in the combustion chamber, a membrane unit for separating oxygen from air, the membrane unit being connected by its oxygen-side removal side to the gasification device via an oxygen pipeline (the desulfurization process potentially also requires oxygen). At the primary side the gas pipeline that branches from the gasification device is connected to a first heat exchanger, so, at the secondary side, the air which can be fed to the heat exchanger may be heated to a process temperature and be fed to the membrane unit. A second heat exchanger is connected at the primary side into the oxygen pipeline and at the secondary side is connected upstream of the membrane unit, so the air that can be fed to the second heat exchanger may be heated, and/or a third heat exchanger is connected at the primary side into a waste air pipeline that branches from the membrane unit and at the secondary side is connected upstream of the membrane unit, so the air that can be fed to the third heat exchanger may be heated.

The second and/or third heat exchanger(s) can be connected to the first heat exchanger in series or in parallel.

If the syngas waste heat is not at a sufficiently high energy level, for example as the gasifier starts up, it is advantageous if a burner is connected to the gas pipeline, upstream of the first heat exchanger, and the gas pipelines can be closed upstream of the burner to bring the membrane to operating temperature by indirect heat exchange with the waste gas from a separate combustion process (with natural gas, syngas, etc.).

It is expedient if the cooled waste gases from the burner, as well as the waste gases from the gas turbine plant, can be fed to a waste heat steam generator for steam generation.

A waste heat steam generator is also advantageous for using the heat from the syngas following passage through the first heat exchanger. The inventive power plant advantageously also comprises a syngas purification device, a CO shift reactor for the CO conversion in the syngas (CO+H₂0−>CO₂+H₂) and a CO2 separating device by means of which CO2 can be separated from the syngas.

With oxygen separation plants that do not operate cryogenically and in which no sufficiently pure nitrogen accumulates during oxygen separation, improved combustion can be achieved by feeding steam to the syngas or by introducing the oxygen-depleted air into the combustion chamber.

In the case of a conventional IGCC power plant it is advantageous if superheated steam can be supplied to the fuel treatment process as a carrier gas and for inerting, as well as to the gasification device.

In the case of a ZEIGCC, i.e. IGCC with CO2 separation, it is advantageous if, during normal operation, appropriately compressed, separated CO2 can be used as an inerting medium or carrier gas. If CO2 separation does not take place, such as, for example, during start-up or in the event of an accident, it is expedient if, as in the case of a conventional power plant, superheated steam can be supplied to the fuel treatment process.

The membrane is advantageously an oxygen ion-conveying membrane.

The power plant preferably comprises a compressor part for providing compressed air for both the oxygen separation plant and the combustion chamber.

### BRIEF DESCRIPTION OF THE DRAWINGS

The invention will be described in more detail with reference to exemplary embodiments which are illustrated in the drawings, in which:

FIG. 1 shows a design for incorporating a membrane-based oxygen separation plant in the IGCC process,

FIG. 2 shows a design for incorporating a membrane-based oxygen separation plant in the IGCC process with an additional burner,

FIG. 3 shows an arrangement of the heat exchangers as in FIG. 1,

FIG. 4 shows a parallel arrangement of all three heat exchangers and

FIG. 5 shows an embodiment of syngas conveying at the first heat exchanger.

### DETAILED DESCRIPTION OF INVENTION

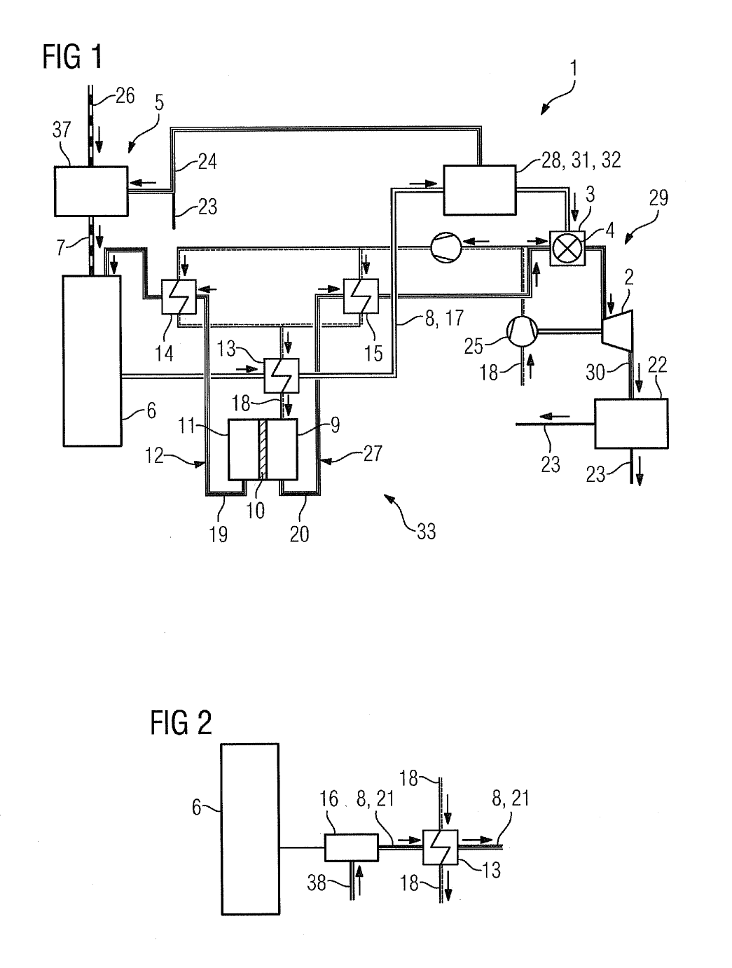

FIG. 1 shows a power plant 1 with integrated gasification device 6 (IGCC plant, integrated gasification combined cycle) and oxygen separation plant 33.

The power plant 1 comprises a gas turbine plant 29, having a compressor part 25, a combustion chamber 3 with at least one burner and a gas turbine 2. At the waste gas side a waste heat steam generator 22 is connected downstream of the gas turbine 2. The waste heat steam generator 22 is connected into the water-steam circuit of a steam turbine (not shown in detail), so a “combined cycle” or combined gas and steam turbine plant (GuD) is achieved. Hot waste gases 30 or burnt gases from the gas turbine 2 heat and in the process evaporate water in the waste heat steam generator 22 to form steam 23 which can be used in the steam turbine or for inerting in the fuel treatment process 37 or for fuel-conveying to the gasification device 6.

The fuel treatment process system 5 comprises a gasification device 6 which comprises a feed pipeline 7 for the fossil fuel and an oxygen pipeline 12 that ends in the gasification device 6. The fossil fuel 26 and the oxygen 19 are partially burnt in the gasification device 6, so a low-calorie combustion gas, the syngas 17, is formed which is fed via a gas pipeline 8 to the burner 4 associated with the gas turbine 2 for combustion purposes.

Oxygen 19 is separated at a process temperature from air 18 in a membrane unit 9 by means of a membrane 10, the separated oxygen 19 being fed from the oxygen-side removal side 11 of the membrane unit 9 via the oxygen line 12 to the gasification device 6 for reaction with the fossil fuel 26.

Heating energy is fed to the membrane 10 to maintain the required process temperature. The heating energy is obtained from the syngas 17 and also from the hot flows of oxygen 19 and oxygen-depleted air 20 in heat exchange with the air 18. The heated air 18 is fed to the membrane 10. In FIG. 1 a first (syngas/air) heat exchanger 13 is connected downstream of the second (oxygen/air) heat exchanger 14 and third (oxygen-depleted air/air) heat exchangers 15 connected in parallel.

The air 18 fed to the membrane 10 is heated in heat exchange with the oxygen 19, the oxygen-depleted air 20 and the syngas 17 to 700° C. to 1000° C., preferably 800° C. to 900° C., to ensure an adequate operating temperature of the membrane unit 9.

After heat exchange with the air 18 the oxygen-depleted air 20 can be fed via the waste air pipeline 27 as cool air to the gas turbine 2 and/or as combustion air to the burner 4.

Before it is fed to the burner 4, the syngas 17 passes through a syngas waste heat utilization device 31, a gas purification device 32 and an optional CO2 separating device 28. The separated CO2 24 can be fed for inerting purposes and as a carrier gas to the fuel treatment process 37. Superheated steam 23 at an appropriate pressure level is used for this purpose in the case of a conventional IGCC power plant (without CO2 separation).

FIG. 2 shows as an exemplary embodiment of the inventive power plant 1 the principle of a membrane-based oxygen separation plant 33 with an additional burner 16 in the case of heat not being available in sufficient form, such as when starting the plant 1, or in the event of an accident. The following descriptions are substantially limited to the differences from the exemplary embodiment in FIG. 1, to which reference is made with respect to features and functions that remain the same. Components that substantially remain the same are basically numbered with the same reference numerals.

The air 18, which is to be fed to the membrane 10, is heated by indirect heat exchange of the air 18 with the waste gas 21 from a separate combustion, for example of natural gas 38. A burner 16 is connected into the gas pipeline 8 between gasification device 6 and first heat exchanger 13 for this purpose. As long as the burner 16 is operating the gas pipeline 8 between gasification device 6 and burner 16 is closed.

FIG. 3 once again shows the interconnection of the heat exchangers already described in FIG. 1. The air 18 is initially divided into two partial flows and flows through the second heat exchanger 14 and third heat exchanger 15 connected parallel to each other, wherein it absorbs heat from the hot oxygen and the hot oxygen-depleted air. For further heating the air flows through the first heat exchanger 13, connected in series with the second 14 and third 15 heat exchangers, where it is heated in heat exchange with the syngas to the required operating temperature of the membrane 10 (see FIG. 1).

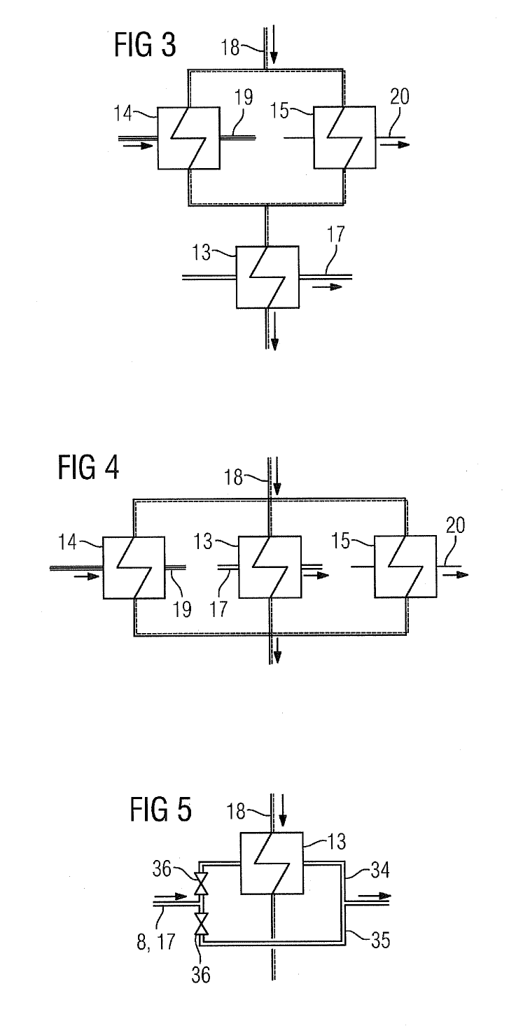

FIG. 4 shows as an exemplary embodiment of the inventive power plant 1 with IGCC process the principle of a membrane-based oxygen separation plant 33 with heat exchangers 13, 14, 15 connected in parallel. Air 18 is divided into three partial flows and in each case heated in indirect heat exchange with either the hot syngas in the first heat exchanger 13 and/or the hot oxygen in the second heat exchanger 14 and/or the hot oxygen-depleted air in the third heat exchanger 15. After heating the partial flows are combined.

FIG. 5 shows alternative conduction of the gas pipeline 8 for the syngas 17 in the region of the first heat exchanger 13. For easier temperature regulation of the air heated in heat exchange with the syngas 17 the gas pipeline 8 is divided into two sub-pipelines 34, 35, a first sub-pipeline 34 leading to the first heat exchanger 13 and a second sub-pipeline 35 being guided around the first heat exchanger 13 as a bypass. Valves 36 regulate the distribution of the syngas 17 between the two sub-pipelines 34, 35.

1.-40. (canceled)

41. A method for operating a power plant with an integrated gasification device, comprising:
gasifying a fuel containing carbon and feeding the gasified fuel as syngas to a burner associated with a gas turbine for combustion purposes;
separating oxygen from air by a membrane at a process temperature such that oxygen-depleted air is formed;
partially feeding the separated oxygen to the gasification device in order to react with the fuel; and
feeding heating energy to the membrane to maintain the required process temperature,
wherein the heating energy is obtained in part from the syngas and in part from the oxygen and/or the oxygen-depleted air in heat exchange with the air, and
wherein the heated air is fed to the membrane.

42. The method as claimed in claim 41, wherein the heat exchange between oxygen and air and/or between oxygen-depleted air and air is connected in series with the heat exchange between syngas and air.

43. The method as claimed in claim 42, wherein the air is firstly heated in heat exchange with the oxygen and/or oxygen-depleted air and then in heat exchange with the syngas.

44. The method as claimed in claim 41, wherein the heat exchange between oxygen and air and/or between oxygen-depleted air and air is connected in parallel with the heat exchange between syngas and air.

45. The method as claimed in claim 41, wherein the air in the heat exchange is heated to 700° C. to 1000° C.

46. The method as claimed in claim 41, wherein, in order to start the membrane, the heating energy is obtained from waste gas from a separate combustion process in heat exchange with the air.

47. The method as claimed in claim 46, wherein, following the heat exchange with the air, the waste gas is cooled and used in a waste heat steam generator in order to generate steam.

48. The method as claimed in claim 41, wherein, following the heat exchange with the air, the syngas is cooled and used in a waste heat steam generator in order to generate steam.

49. The method as claimed in claim 41, wherein, following the heat exchange with the air, the syngas is purified.

50. The method as claimed in claim 41, wherein the syngas is subjected to a CO shift reaction.

51. The method as claimed in claim 50, wherein CO2 is separated from the syngas following the CO shift reaction.

52. The method as claimed in claim 41, wherein the syngas is diluted with steam (H₂O).

53. The method as claimed in claim 41, wherein the air is removed as compressor exhaust air from a compressor part associated with the gas turbine.

54. The method as claimed in claim 53, wherein the air is removed at the compressor outlet after the end stage or is removed at a lower compressor air pressure level.

55. The method as claimed in claim 41, wherein the cooled and oxygen-depleted air is fed to the burner as combustion air.

56. The method as claimed in claim 41, wherein waste gases from the gas turbine are used in a waste heat steam generator of the gas turbine in order to generate steam.

57. The method as claimed in claim 47, wherein the fuel is rendered inert with superheated steam as it is conveyed to the gasification device.

58. The method as claimed in claim 51, wherein the fuel is rendered inert with CO2 separated from the syngas as it is conveyed to the gasification device.

59. A power plant, comprising:
a gas turbine;
a combustion chamber with at least one burner being associated to the gas turbine;
a fuel system connected upstream of the combustion chamber;
a gasification device with a fuel feed pipeline for fossil fuel and a gas pipeline that branches from the gasification device and ends in the combustion chamber;
a membrane unit with a membrane for separating oxygen from air, the membrane unit being connected by its oxygen-side removal side to the gasification device via an oxygen pipeline;
a first heat exchanger;
a second heat exchanger; and
a third heat exchanger,
wherein, at a primary side, the gas pipeline that branches from the gasification device is connected to the first heat exchanger such that, at a secondary side, the air which is fed to the heat exchanger is heated to a process temperature and fed to the membrane unit, and
wherein the second heat exchanger is connected at the primary side into the oxygen pipeline and at the secondary side upstream of the membrane unit, such that the air that is fed to the second heat exchanger is heated, and/or
wherein the third heat exchanger is connected at the primary side into a waste air pipeline that branches from the membrane unit and at the secondary side upstream of the membrane unit, such that the air that is fed to the third heat exchanger is heated.

60. The power plant as claimed in claim 59, further comprising:
a gas purification device for purifying a syngas;
a CO shift reactor for a CO conversion;
a CO2 separating device for separating CO2 from the syngas; and
a compressor for providing compressed air.
